(19) United States
(12) Patent Application Publication
(10) Pub. No.: US 2004/0254679 A1
(43) Pub. Date: Dec. 16, 2004

(54) Robot movement control system

(76) Inventor: Kenichiro Nagasaka, Tokyo (JP)

Correspondence Address: FROMMER LAWRENCE & HAUG LLP, 745 FIFTH AVENUE, NEW YORK, NY, 10151, US

(21) Appl. No.: 10/822,199

(22) Filed: Apr. 9, 2004

(30) Foreign Application Priority Data
Apr. 10, 2003 (JP) 2003-106166

(51) Int. Cl. G06F 19/00

(52) U.S. Cl. 700/245

(57) ABSTRACT

A plurality of tasks such as a displacement, balance keeping, and an arm operation are simultaneously executed. Movement constraint conditions imposed to a legged robot corresponding to a task and a movement state are given by equality and inequality constraint equations regarding to a variation dx from the present state while a drive strategy of a redundancy is defined by an energy function. In regard to changes in a movement constraint condition, it is not required to have control systems specialized for each constraint condition but the changes can be corresponded only by changes in matrixes A and C and vectors b and d, so that various and dynamic constraint conditions are easily addressed. Also, a using method of the redundancy can be corresponded only by changes in a matrix W and a vector u.

### BACKGROUND OF THE INVENTION

1. Field of the Invention

The present invention relates to a legged walking robot having at least a plurality of movable legs, and in particular relates to a movement control system for a legged walking robot capable of simultaneously executing a plurality of tasks such as a displacement, balance keeping, and an arm operation.

In more detail, the present invention relates to a movement control system for a legged walking robot capable of determining the allocation of the driving amount of each joint in real time so as to simultaneously satisfy various movement constraint conditions imposed by each task, and in particular relates to a movement control system for a legged walking robot capable of operating by suitably allocating drive amounts of degrees of freedom of an entire body so as to simultaneously satisfy geometrical/dynamical and ever-changing various movement constraint conditions.

2. Description of the Related Art

A robot is a mechanical device which emulates the movement of a human being by making use of an electrical or magnetic action. The term robot is said to be derived from the Slavic word ROBOTA (slavish machine).

In recent years, progress has been made in the research and development of legged mobile robots which emulate the movements and mechanisms of the body of an animal, such as a human being or a monkey, which walks on the two feet while in an erect posture, so that there is a higher expectation of putting them into practical use. Legged mobile robots which emulate the mechanism and movements of the bodies of human beings are especially called humanoid robots.

The legged mobile robot is excellent in that it can achieve flexible walking operation, such as hurdling obstacles regardless of a non-finished ground and moving up and down a step or a ladder although the legged mobile robot is unstable and difficult to be controlled in posture and walking in comparison with a crawler-mounted robot and a robot on four-feet or six-feet.

In comparison with industrial robots such as manipulators and carrier robots, legged mobile robots are characterized in that they are defined by multiple link systems including redundancies. Using such characterization, a plurality of tasks such as a displacement, balance keeping, and an arm operation can be simultaneously executed.

On the other hand, a method is not axiomatic for determining the allocation of the driving amount of each joint in real time so as to simultaneously satisfy various movement constraint conditions imposed by a plurality of tasks. In particular, since such movement constraint conditions ever change corresponding to operation environments/executing tasks of a legged mobile robot, it is required to have an algorithm capable of corresponding to changes in the movement constraint conditions in response to execution.

For example, a biped with two arms robot is assumed to have situations imposed by the following movement constraint conditions:

1) legs and hands are constrained on a floor when the robot gets up on the hands from a lying-on-face posture;

2) the hands are constrained on a wall when the robot gets up by touching the hands on the wall;

3) hands are constrained on a uniform linear moving track when the robot conveys an object without swinging; and

4) both hands are constrained on a both-hands track when two robots operate hand in hand.

Also, in order to maintain a dynamic balance, the following dynamic movement-constraint conditions are simultaneously imposed:

1) the constraint to a translational momentum (gravity center track) of a robot; and

2) the constraint to an angular momentum of the robot.

Furthermore, in view of characteristics of actuators defining degrees of joints, situations are supposed where the following inequality constraints are imposed:

1) the constraint to a movable range of an actuator of a joint; and

2) the constraint to a drive rate of the actuator of the joint.

Therefore, the legged mobile robot represented by the humanoid robot must operate by suitably allocating drive amounts of degrees of freedom of the entire body so as to simultaneously satisfy ever changing various movement constraint conditions.

As a study relating to a method for allocating drive amounts of joints of the entire body of a legged robot, there is a proposal of a method allocating drive amounts of degrees of freedom of the entire body for maintaining the standing balance on one foot while when an angular planned value of the entire body joints of a legged mobile robot is given, the planned value is reflected to the utmost (see “the dynamic balance compensation in real time using the entire body in the standing operation on one foot of a humanoid robot” by Tamiya et al., Journal of the Robotics Society of Japan, Vol. 17, No. 2, pp. 268-274, 1966).

However, since object problems of this method are limited to the standing state on one-foot; the entire body joints are used only for maintaining the balance; and there is no mention on a method for imposing an arbitrary geometrical constraint, the method does not satisfy the above-mentioned requirement of simultaneously satisfying the various movement constraint conditions.

Many of proposals made to prevent a legged mobile robot from falling down while it is walking use a ZMP (zero moment point) as a norm for determining the walking stability. The norm for determining the stability by the ZMP is based on the D'Alembert principle that in a walking system, gravitational forces, inertial forces, and moments thereof applied on a road surface balance reaction forces and reaction moments from the road surface. As a consequence of the dynamic postulation, there exists a point where the pitch axis moment and the roll axis moment become zero on or within a side of a support polygon defined by the surface of a path and points where soles contact the floor. In other words, a ZMP exists (see “legged locomotion robots” by Miomir Vukobratovic, and “walking robots and artificial legs” by Kato et al., published from Nikkan Kogyo Shinbun, for example). The generation of a pattern for walking on two feet based on the ZMP as a norm has the advantage of allowing previous setting of the points where the soles contact the floor, making it easier to take into consideration kinematic constraint conditions of the toes in accordance with shapes of the path. Also, using the ZMP as a norm for determining the stability means that a target value of the movement control is not a force but a track, so that the technical feasibility is increased.

An example is reported in that based on the ZMP norm for determining the stability, a pattern for walking on two feet is generated by compensating the moment about the ZMP in operative coordination with a plurality of regions (see “the development of a biped walking humanoid robot—the biped walking control with the entire body coordination” by Yamaguchi et al., from the manuscript copies prepared for the third robotics symposia, pp. 189-196, 1998, for example).

However, also in this case, since object problems of this method are limited to walking; and there is no mention on a framework for imposing/relieving an arbitrary geometrical constraint, it is inferred that the method do not satisfy the above-mentioned requirement of simultaneously satisfying the various movement constraint conditions.

The inventors point out the following reasons why conventional body-control algorithms cannot operate by suitably allocating drive amounts of degrees of freedom of an entire body so as to simultaneously satisfy ever-changing various movement constraint conditions:

First, it is mentioned that the conventional body-control algorithms can add only small-numbered limited movement constraints on a specific problem.

The movement constraints can be generated in not only the walking or standing but also in every movement states. At not only end points but also at positions/postures of every regions of the body, various constraints may be simultaneously generated, such as geometrical constraints, constraints over momentums of an entire system, and inequality constraints relating to the movable range/drive rate of actuators. In order to exhibit the functions of a legged robot with multiple redundancies to the utmost, it is considered that an algorithm capable of freely imposing these various constraints without being limited by specific movement states is necessary.

Secondly, there may be few algorithms capable of corresponding to changes in dynamic movement-constraint conditions.

The above-mentioned movement-constraint conditions are ever variable corresponding to tasks required and movement states of a robot. For example, when a legged mobile robot avoids an obstacle above the head, a geometrical constraint is imposed on a head positional track while the head is approaching the obstacle; then, the geometrical constraint is relieved after the head avoids the obstacle. Alternatively, when the load increase is detected at a specific joint, for protecting this joint, there may be a situation that a geometrical constraint is imposed so that a gait must be changed so as to maintain the balance using another region. If the robot cannot instantly reflect the movement constraint conditions changing in time to the movement in such a manner, the degree-of-freedom resources of the legged robot cannot be efficiently utilized, so that a legged robot capable of flexibly corresponding to tasks required cannot be achieved.

Thirdly, there is no mention other than a fixed and unique strategy regarding to the drive method of redundancies.

The drive method of the redundancies of the legged mobile robot is dynamically changeable by body conditions and kinds of tasks. There may be situation assumptions that redundancies are wanted and consumed for achieving the movement close to the general movement given in advance to the utmost while the appearance is weighted; and for reducing the load on an actuator, the joint drive amount is wanted and used to the utmost. In order that a legged robot efficiently drives the redundancy in accordance with situations, it is desirably considered to have a plurality of drive strategies of the redundancies so as to be dynamically changeable.

### SUMMARY OF THE INVENTION

It is an object of the present invention to provide an excellent movement control system for legged walking robots capable of simultaneously executing a plurality of tasks such as a displacement, balance keeping, and an arm operation.

It is a further object of the present invention to provide an excellent movement control system for legged walking robots capable of determining the allocation of drive amounts of joints in real time so as to simultaneously satisfy various movement constraint conditions imposed by each task.

It is a further object of the present invention to provide an excellent movement control system for legged walking robots capable of operating by suitably allocating drive amounts of degrees of freedom of an entire body so as to simultaneously satisfy geometrical/dynamical and ever-changing various movement constraint conditions.

The present invention has been made in view of the problems described above, and in accordance with a first aspect of the present invention, in a movement control system for a robot having a base and a plurality of movable regions connected to the base, the system includes fundamental constraint-condition setters for setting movement constraint-conditions, which are imposed in accordance with a task and a movement state applied to the robot, for each kind of constraint; a constraint-condition setting unit for imposing the movement constraint conditions of the entire robot necessary for a state variation of the robot by selectively using the appropriate fundamental constraint-condition setter in accordance with a movement-constraint requirement produced during execution of a task and a movement of the robot; and a drive-amount determining unit for determining a drive amount of each of the movable regions so as to satisfy the entire movement-constraint conditions set by the constraint-condition setting unit.

Wherein the robot is a biped legged walking robot with two arms, for example. The plurality of movable regions include at least the upper limb, the lower limb, and the body section. A posture angle of the robot can be expressed using a virtual joint angle of a virtual link.

The fundamental constraint condition setter provided for each kind of constraint expresses the movement constraint condition imposed corresponding to a task and a movement state of the robot as a linear equality equation of the state variable variation. That is, there are provided fundamental constraint condition setters for establishing constraint conditions every kinds of constraints such as a link original-point position, a link posture, a link gravity center position, a joint angle, an entire gravity center position, and an entire angular momentum. Each fundamental constraint condition setter has a function to generate a parameter for describing a linear constraint equation regarding to the corresponding kind of constraint. In accordance with various equality constraint demands generated during execution of a task, by selectively using such a fundamental constraint condition setter, linear equality movement constraint conditions can be generated for the entire robot.

Alternatively, the fundamental constraint condition setter provided for each kind of constraint expresses the movement constraint condition imposed corresponding to a task and a moving state of the robot using a linear inequality equation of a joint angular variation, etc. For example, there are provided fundamental constraint setters for establishing movement constraint conditions every kind of constraints such as an angular velocity limit and a movable angle limit of joints, and each fundamental constraint setter has a function to generate a parameter for describing the linear inequality equation regarding to the corresponding kind of constraint. In accordance with various inequality-constraint demands generated during execution of a task, by selectively using such a fundamental constraint setter, movement constraint conditions defined by the linear inequality equations about the entire robot can be generated.

In accordance with a second aspect of the present invention, in a movement control system for a robot having a base and a plurality of movable regions connected to the base, the system includes fundamental redundancy drive-method setters for setting redundancy drive-methods, which are changed in accordance with a task and a movement state applied to the robot, for each kind of norm; a redundancy drive-method setting unit for setting redundancy drive-methods of the entire robot by selectively using the appropriate fundamental redundancy drive-method setter in accordance with a requirement for changes generated during execution of a task and a movement of the robot; and a drive-amount determining unit for determining a drive amount of each of the movable regions so as to satisfy the redundancy drive-method set by the redundancy drive-method setting unit.

As norms for driving redundancies, there are the minimization of system state changes and the minimization of the target state deviation, for example. In accordance with demands for changes in the redundancy drive method generated during execution of a task, by selectively using the corresponding fundamental redundancy drive-method setter, redundancy drive methods can be variously established for the entire robot.

Also, in accordance with a third aspect of the present invention, in a movement control system for a robot having a base and a plurality of movable regions connected to the base, the system includes equality-constraint condition setters for expressing movement constraint-conditions, which are imposed in accordance with a task and a movement state applied to the robot, for each kind of constraint by a linear equality equation of a variation of a state variable; an equality-constraint condition setting unit for imposing movement-constraint conditions of the entire robot necessary for a state variation of the robot by selectively using the appropriate equality-constraint condition setter in accordance with a requirement for a movement constraint generated during execution of a task and a movement of the robot; inequality-constraint condition setters for expressing movement constraint-conditions, which are imposed in accordance with a task and a movement state applied to the robot, for each kind of constraint by a linear inequality equation of a variation of a state variable; an inequality-constraint condition setting unit for imposing movement-constraint conditions of the entire robot necessary for a state variation of the robot by selectively using the appropriate inequality-constraint condition setter in accordance with a requirement for a movement constraint generated during execution of a task and a movement of the robot; fundamental redundancy drive-method setters for setting redundancy drive-methods, which are changed in accordance with a task and a movement state applied to the robot, for each kind of norm; a redundancy drive-method setting unit for setting redundancy drive-methods of the entire robot by selectively using the appropriate fundamental redundancy drive-method setter in accordance with a requirement for changes generated during execution of a task and a movement of the robot; and a drive-amount determining unit for determining a drive amount of each of the movable regions so as to entirely satisfy equality and inequality-constraint conditions of the entire robot set by the equality-constraint condition setting unit and the inequality-constraint condition setting unit, and to entirely satisfy redundancy drive-methods of the entire robot set by the redundancy drive-method setting unit.

In such a case, equality and inequality constraint conditions about the entire robot and redundancy drive methods about the entire robot can be formulated as quadratic programming problems. This quadratic programming problem can be solved using a numerical analysis method such as a dual method, and the variation of the state variable of the robot can be obtained (or when the inequality constraint is out of consideration, the problem can also be analytically solved using a Lagrange multiplier method, etc.). Then, by integrating this state variable variation, the state of the robot at a succeeding time can be obtained.

Therefore, when the robot simultaneously executes a plurality of tasks, the allocation of the drive amount of each joint can be determined in real time so as to simultaneously satisfy geometrical/dynamical and ever-changing various movement constraint conditions.

According to the present invention, in a legged mobile robot arbitrarily structured with open links, arbitrary constraints expressed by linear equality equations and linear inequality equations regarding to state variations can be imposed, such as geometrical constraints about positions and postures at every points of links, constraints about the entire momentums, and inequality constraints about movable ranges and drive velocities of actuators. That is, various movement constraints can be imposed to a legged mobile robot in an arbitrarily moving state, enabling more various tasks to be executed.

The movement constraints imposed to a legged mobile robot are changeable in time corresponding to the moving state and the demanded task of the robot. According to the present invention, to such ever changeable constraint conditions, the system can correspond not with a fixed individual algorithm (such as inverted kinematics using analytical solution) but with a simplified and unified framework that is value changing in a matrix element. Therefore, the system can easily and promptly correspond to ever changing various constraint conditions, achieving a legged robot capable of flexibly corresponding to demanded tasks.

In the control system according to the present invention, for the drive method of redundancies, a plurality of drive strategies of the redundancies are established so as to be dynamically switchable. The optimum drive method of redundancies of a legged robot is dynamically changeable according to the robot conditions and kinds of task. According to the present invention, a plurality of redundancy drive methods such as the minimization of the deviation of the target state of the system given in advance and the minimization of system state changes can be changed only by the establishing method of the matrix value, easily achieving a legged robot driven according to situations based on the optimum coordinating method of the entire body.

Other objects, features, and advantages of the present invention will become apparent as the following detailed description proceeds based on the embodiment of the present invention and the attached drawings.

### BRIEF DESCRIPTION OF THE DRAWINGS

FIG. 1 is a drawing showing a configuration of degrees of freedom of a biped humanoid robot with two arms exemplified in the present invention;

FIG. 2 is a drawing illustrating a base posture of the legged mobile robot shown in FIG. 1;

FIG. 3 is a schematic block diagram showing a configuration of a movement control system for a legged walking robot according to an embodiment of the present invention;

FIG. 4 is a flowchart showing control procedures achieved by the movement control system for the legged walking robot shown in FIG. 3;

FIG. 5 is a drawing for illustrating the definition of a coordinate system; and

FIG. 6 is a drawing showing an example in that the control system according to the present invention is incorporated in arising movement control of the legged mobile robot.

### DESCRIPTION OF THE PREFERRED EMBODIMENTS

The present invention provides a control unit for determining the allocation of a drive amount for each joint in real time so as to simultaneously satisfy various movement constraint conditions imposed to a legged mobile robot during operation. According to the present invention, the legged mobile robot is enabled to flexibly correspond to changes in a complicated state of touching ground and to easily execute a plurality of tasks simultaneously. An embodiment of the present invention will be described below in detail with reference to the drawings.

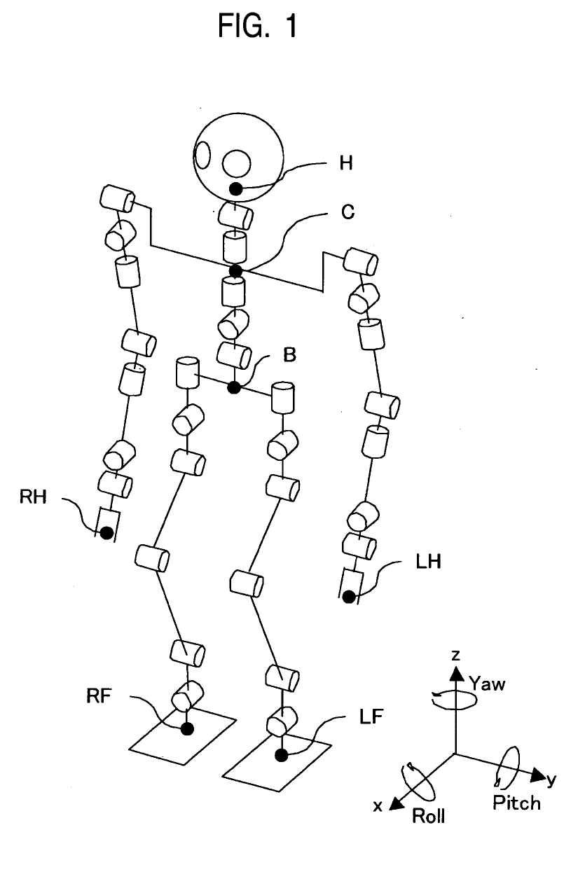

FIG. 1 shows a configuration of degrees of freedom of a biped humanoid robot with two arms exemplified in the embodiment of the present invention.

The robot according to the embodiment is constructed by open link chain trains radially linking via rotary joints from a base B, and composed of an arm section with seven degrees of freedom, a leg section with six degrees of freedom, a waist section with three degrees of freedom, and a head with two degrees of freedom.

The base B is defined by an intersecting point between a line connecting lateral hip joints together and a body yaw axis. The leg section is connected to the base B, and composed of a hip joint with three degrees of freedom (yaw, roll, and pitch), a knee joint with one degree of freedom (pitch), and an ankle joint with two degrees of freedom (roll and pitch). The hip section with three degrees of freedom (yaw, roll, and pitch) is connected to the base B and a chest section C. The arm section is connected to the chest section C, and composed of a shoulder joint with three degrees of freedom (yaw, roll, and pitch), an elbow joint with two degrees of freedom (yaw and pitch), and a wrist joint with two degrees of freedom (roll and pitch). The head is connected to the chest section C, and composed of a neck joint with two degrees of freedom (pan and tilt).

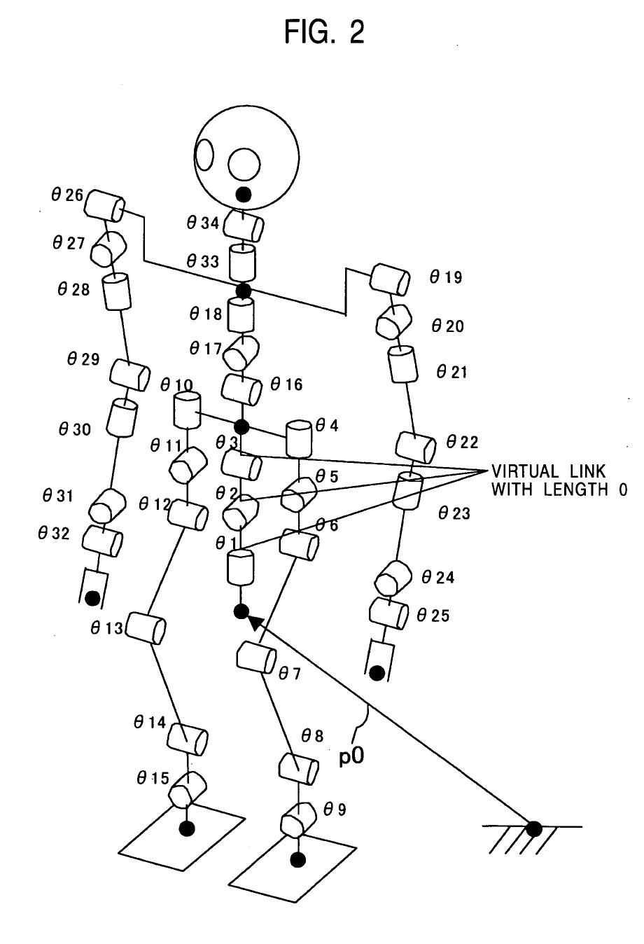

The state of the legged mobile robot can be expressed by a state variable x=[pₒ, αₒ, θ]^{T} given by arranging a position pₒ=(x, y, z) T, an attitude αₒ=(θ₁, θ₂, θ₃)^{T} of the base B in a world coordinate system (Eulerian angles expression, for example), and the entire joint angles θ=[θ₄, . . . θₙ]^{T}.

Wherein the attitude of the base, as shown in FIG. 2, is expressed by a virtual joint angle θ₁, θ₂, θ₃ of a virtual link with length 0. Where n is the number of joints including virtual joints (in the example shown in FIG. 1, n=34), and θᵢ (i=1 . . . n) expresses the joint angle of the joint i. Also, the number of elements N of a state variable is set to be N=n+3 (in the example shown in FIG. 1, N=37). However, without introducing the virtual link, the technical concept of the present invention can be achieved.

In the description below, the present state is x (vector), and the variation of the present state x after an elapse of minute time dt is dx, so that the movement constraint condition is defined with the dx. In particular, as shown in equations below, it is considered to impose a constraint condition to a movement with a linear equality or inequality equation.

Adx=b [Numerical Formula 1]

Cdx≧d [Numerical Formula 2]

In the description below, the formulas 1 and 2 are called as an “equality constraint condition” and an “inequality constraint condition”, respectively. Where A is an L×N matrix; b a vector of dimension L; C an M×N matrix; and d a vector of dimension M, and symbol L denotes the number of equality constraint conditions; and symbol M the number of inequality constraint conditions. In a control system for the legged mobile robot according to the embodiment, a state variation dx is calculated so as to satisfy the above-mentioned equations every a predetermined control cycle, so that the entire body joints are driven so as to achieve x′=x+dx, in which a present state x is added by dx.

The number of constraint conditions L is generally less than the dimension of the state variable N. Therefore, the state variation dx is not uniquely determined only by [Numerical Formula 1] and [Numerical Formula 2]. That is, N−L is equivalent to a redundancy, and the drive method of this redundancy must be separately established. Whereas, according to the present invention, dx is to be established so as to minimize an energy function relating to the state variation dx as follows.

$$E = \frac{1}{2} d {x}^{T} \cdot W \cdot d x + {u}^{T} \cdot d x \qquad [ Numerical Formula 3 ]$$

Where W is a symmetric matrix of N×N; and u a vector of dimension N. Then, the subject for obtaining the joint angular variation dx is formulated as a quadratic programming problem which will be shown below.

[Numerical Formula 4]

$$min E = \frac{1}{2} d {x}^{T} \cdot W \cdot d x + {u}^{T} \cdot d x$$

$$subject to A d x = b , C d x ≧ d$$

This quadratic programming problem can be solved using a numerical analysis method such as a dual method. When the inequality constraint is out of consideration, the problem can also be analytically solved using a Lagrange multiplier method, etc.

That is, according to the present invention, movement constraint conditions imposed to the legged robot corresponding to a task and a movement state are given by the linear constraint equations [Numerical Formula 1] and [Numerical Formula 2] regarding to the variation dx from the present state, while the drive strategy of the redundancy is defined by the energy function [Numerical Formula 3]. In regard to changes in the movement constraint condition, it is not required to have control systems specialized for each constraint condition but the changes can be corresponded only by changes in the matrixes A and C and the vectors b and d, so that various and dynamic constraint conditions are easily addressed. Also, regarding to the using method of the redundancy, it can be corresponded only by changes in the matrix W and the vector u, so that various and dynamic drive methods of the redundancy may be provided.

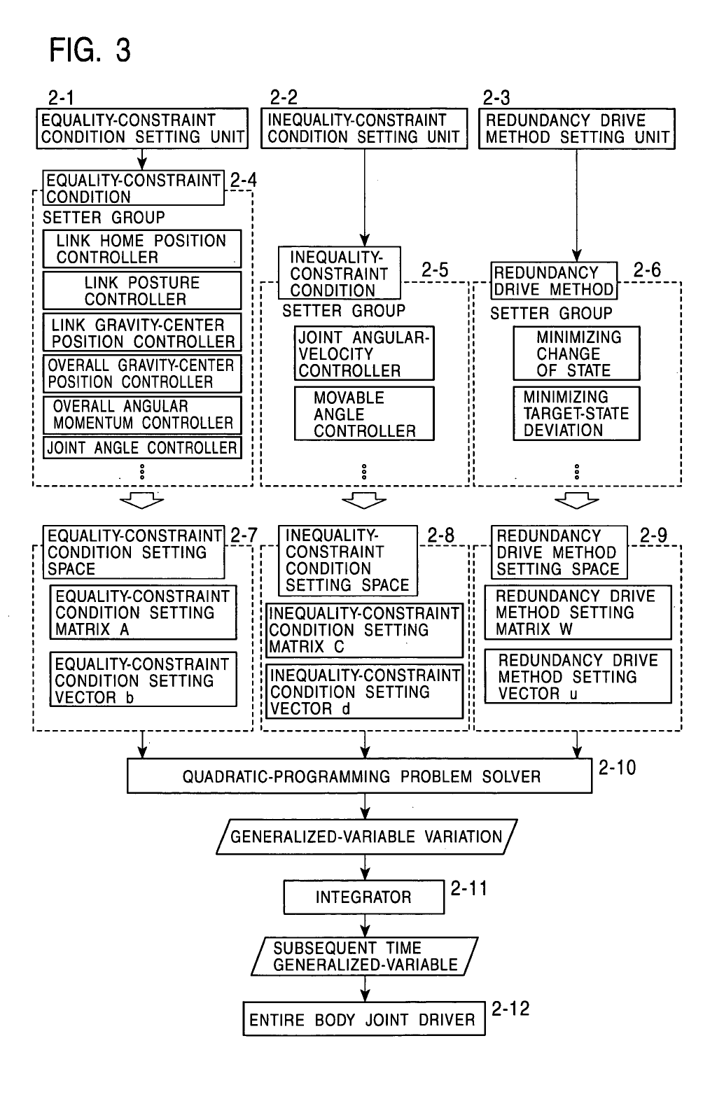

FIG. 3 schematically shows the configuration of the movement control system for the legged walking robot according to the embodiment of the present invention. As shown in the drawing, this movement control system is defined by an equality-constraint condition setting unit 2-1, an inequality-constraint condition setting unit 2-2, a redundancy drive method setting unit 2-3, an equality-constraint condition setter group 2-4, an inequality constraint-condition setter group 2-5, a redundancy drive method setter group 2-6, an equality-constraint condition setting space 2-7, an equality-constraint condition setting space 2-8, a redundancy drive method setting space 2-9, a quadratic-programming problem solver 2-10, an integrator 2-11, and an entire body joint driver 2-12.

The equality-constraint condition setting unit 2-1 sets the conditions expressed by a linear equality equation of the state variable variation among constraint conditions imposed to the robot corresponding to a task and a movement state thereof. For example, the conditions correspond to constraints regarding to an original point position of a link, a link posture, a gravity center position of a link, a joint angle, a gravity center position of the entire body, and an entire angular momentum.

These constraint conditions expressed by linear equality equations are established in the matrix A and the vector b within the equality-constraint condition setting space 2-7. The equality-constraint condition setter group 2-4 is provided with equality-constraint condition setters for setting constraint conditions every constraints (or controlled objects), such as an original point position of a link, a link posture, a gravity center position of a link, a joint angle, a gravity center position of the entire body, and an entire angular momentum. Each equality-constraint condition setter has a function to generate a parameter for describing a linear constraint equation regarding to the corresponding kind of constraint. According to the embodiment, the equality-constraint condition setters linearly express the constraint equations in a Jacobian form, which will be described later in detail.

Then, the equality condition setting unit 2-1 appropriately uses the corresponding equality-constraint condition setter selected from the equality-constraint condition setter group 2-4 corresponding to various equality constraint demands generated during executing a task so as to establish an appropriate value in the matrix A and the vector b within the equality-constraint condition setting space 2-7, resulting in generating constraint conditions of the entire robot by liner equality equations.

The inequality constraint condition setting unit 2-2 establishes conditions expressed by linear inequality equations such as an angular variation of a joint among constraint conditions imposed corresponding to a task and a movement state of the robot. For example, these correspond to constraints regarding to an angular velocity limit and a movable angle limit of joints.

These constraint conditions expressed by the linear inequality equations are established in the matrix C and the vector d within the inequality-constraint condition setting space 2-8. The inequality constraint condition setter group 2-5 is provided with inequality-constraint condition setters for setting constraint conditions every constraints (or controlled objects), such as an angular velocity limit and a movable angle limit of joints. Each inequality-constraint condition setter has a function to generate a parameter for describing a linear inequality equation regarding to the corresponding kind of constraint. A more specific structuring method of the inequality constraint condition setter will be described later in detail.

Then, the inequality condition setting unit 2-2 appropriately uses the corresponding inequality-constraint condition setter selected from the inequality-constraint condition setter group 2-5 corresponding to various inequality constraint demands generated during executing a task so as to establish an appropriate value in the matrix C and the vector d within the inequality-constraint condition setting space 2-8, resulting in generating constraint conditions of the entire robot by liner inequality equations.

The redundancy drive method setting unit 2-3 establishes drive methods of redundancies changing corresponding to a task and a movement state of the robot. In the drive method of the redundancy, there may be the norms of the minimization of system state changes and the minimization of the target state deviation.

These norms for driving redundancies are established in the matrix W and the vector u within the redundancy drive method setting space 2-9. The redundancy drive method setter group 2-6 is provided with a fundamental redundancy drive method setter for setting redundancy drive methods every norms such as the minimization of system state changes and the minimization of the target state deviation. Each fundamental redundancy drive method setter generates the redundancy drive method according to the corresponding norm.

Then, the redundancy drive method setting unit 2-3 appropriately uses the corresponding drive method selected from the redundancy drive method setter group 2-6 corresponding to change demands generated during executing a task so as to establish an appropriate value in the matrix W and the vector u within the redundancy drive method setting space 2-9, resulting in establishing desired redundancy drive methods of the entire robot.

The quadratic programming problem solver 2-10 formulates the equality-constraint conditions established in the equality-constraint condition setting space 2-7, the inequality constraint conditions established in the inequality constraint condition setting space 2-8, and the inequality constraint drive methods established in the redundancy drive method setting space 2-9 as quadratic programming problems (see the above-description and [Numerical Formula 4]) so as to calculate the state variable variation dx simultaneously satisfying these constraint conditions and the redundancy drive methods.

The integrator 2-11 calculates the state variable value at a succeeding time x=x+dx by adding the state variable variation dx calculated by the quadratic programming problem solver 2-10 to the present state variable value x. The entire body joint driver 2-12 servo-drives each joint (position) in the robot based on the state variable value at a succeeding time calculated by the integrator 2-11.

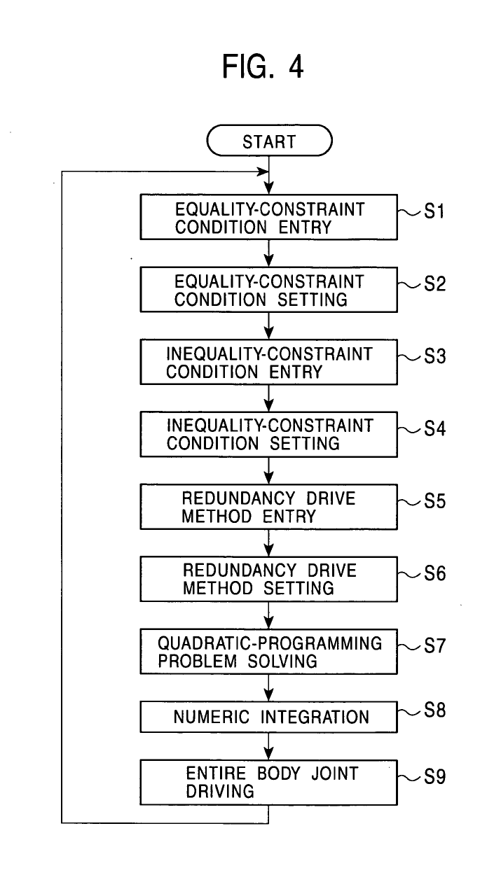

FIG. 4 is a flowchart of the control procedure achieved by the movement control system for the legged walking robot shown in FIG. 3.

First, equality constraint conditions regarding to an original point position of a link, a link posture, a gravity center position of a link, a joint angle, a gravity center position of the entire body, and an entire angular momentum are entered corresponding to a task and a movement state of the robot from a user program, for example (Step S1).

Then, when the equality-constraint conditions entered at the previous step S1 are entered in the equality-constraint condition setting unit 2-1, the values are established for imposing the equality-constraint conditions to the equality-constraint condition setting matrix A and the equality-constraint condition setting vector b within the equality-constraint condition setting space 2-7 by selectively using the equality-constraint condition setter group 2-4 (Step S2).

Next, the inequality constraint conditions regarding to an angular velocity limit and a movable angle limit of joints are entered from a user program, for example (Step S3).

Then, when the inequality-constraint conditions entered at the previous step S3 are entered in the inequality-constraint condition setting unit 2-2, the values are established for imposing the inequality-constraint conditions to the inequality-constraint condition setting matrix C and the inequality-constraint condition setting vector d within the inequality-constraint condition setting space 2-8 by selectively using the inequality-constraint condition setter group 2-5 (Step S4).

Next, the redundancy drive methods are entered according to situations and based on the norms such as the minimization of system state changes and the minimization of the target state deviation from a user program, for example (Step S5).

Then, the redundancy drive methods entered at the previous step S5 are entered in the redundancy drive method setting unit 2-3, and the appropriate values are established in the redundancy drive method setting matrix W and the redundancy drive method setting vector u within the redundancy drive method setting space 2-9 via the redundancy drive method setter group 2-6 (Step S6).

Next, the quadratic programming problems (see the above-description and [Numerical Formula 4]) established in the equality-constraint condition setting space 2-7, the inequality constraint condition setting space 2-8, and the redundancy drive method setting space 2-9 at steps S2, S4, and S6 are solved so as to calculate the state variable variation dx so as to simultaneously satisfy the constraint conditions and the redundancy drive methods designated by a user (Step S7).

Furthermore, using the integrator 2-11, the state variable variation is numerically integrated so as to obtain the state variable value at a succeeding time (Step S8).

Then, the joint angular value at a succeeding time calculated at the previous step S8 is fed to the entire body joint driver 2-12 as a reference value so as to perform a positional servo.

The above procedures are executed every a predetermined control cycle dt (dt=10 milliseconds, for example).

The equality-constraint condition setter group 2-7 will be described below with reference to a specific example.

As described above, the equality-constraint condition is expressed by a linear constraint equation regarding to the variation dx of the present state x after an elapse of minute time dt (see [Numerical Formula 1]). According to the embodiment, a Jacobian form is used for linearly expressing the relationship between minute variations.

For example, a fundamental constraint condition setter for a link original-point position may be configured using a Jacobian form regarding to the original point position in a link coordinate system. In this specification, a link connected to a parent link via the joint i denotes the link i; and a link coordinate system is designated by a coordinate system identical in posture to the link i placed at the interface between the parent link and the link i. The original point position velocity dp_i/dt (three dimension vector) of the link i can be expressed by Jacobian Jₚ₋ᵢ (3×N matrix) regarding to the original point position velocity of a state variable velocity dx/dt (N dimension vector).

$$\frac{dp\_i}{d t} = {J}_{p\_i} \frac{d x}{d T} \qquad [ Numerical Formula 5 ]$$

The Jacobian Jₚ₋ᵢ regarding to the original point position velocity of the link i can be obtained by the following equations:

the first row of Jₚ_{_{—}}ᵢ=[1, 0, 0]^{T}

the second row of Jₚ_{_{—}}ᵢ=[0, 1, 0]^{T}

the third row of Jₚ_{_{—}}ᵢ=[0, 0, 1]^{T} [Numerical Formula 6]

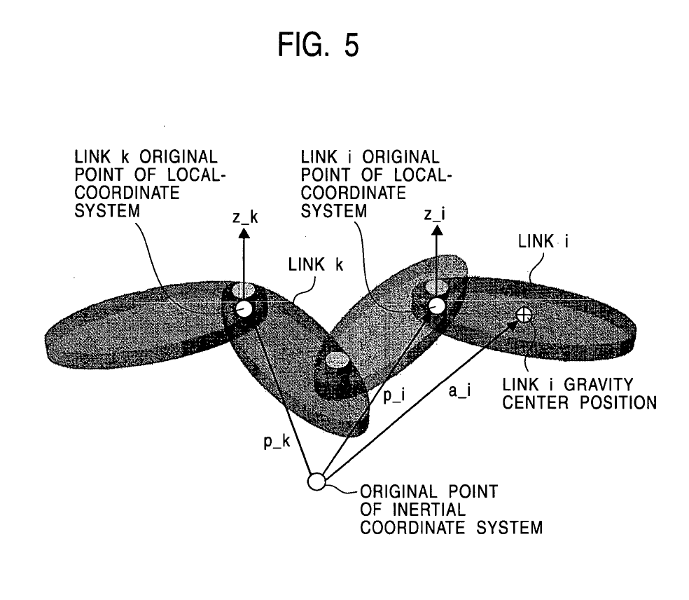

the (k+3)th row of Jₚ_{_{—}}ᵢ=0 (in the case where the link k does not exist on the straight line connecting between the base B and the link i), or z_k×(p_i−p_k) (in the case where the link k does not exist on the straight line connecting between the base B and the link i).

Wherein the z_k expresses the vector of the joint k in the rotation axial direction; and the P_i and the p_k designate the positions of the link i and the link k, respectively (see FIG. 5). From the above [Numerical Formula 5], between the original point position minute variation dp_i of the link i and the minute variation dx of the state variable x, the following relationship is approximately effected:

dp_{—}i=Jₚ_{_{—}}ᵢdx [Numerical Formula 7]

Therefore, in the case where the movement constraint is required and imposed to the original point position of the link i in the x, y, and z directions so as to generate the minute variations dp_ix, dp_iy, dp_iz, respectively, the following equality constraints may be imposed:

dp_{—}ix=Jₚ_{_{—}}ᵢₓdx [Numerical Formula 8]

dp_{—}iy=Jₚ_{_{—}}_{iy}dx [Numerical Formula 9]

dp_{—}iz=Jₚ_{_{—}}_{iz}dx [Numerical Formula 10]

Wherein, Jₚ_{_{—}}ᵢx, Jₚ_{_{—}}ᵢy, and Jₚ_{_{—}}ᵢ z designate the first, second, and third lines of Jₚ_{_{—}}ᵢ, respectively. When a link original point position constraint is demanded to a link original point position controller, the link original point position controller establishes the coefficients of the above equations of [Numerical Formula 8] to [Numerical Formula 10] on new lines of the equality-constraint condition setting matrix A and the equality-constraint condition setting vector b in the equality-constraint condition setting space 2-7. For example, when the constraint regarding to the position in the x direction of the link original point is demanded, according to the equation [Numerical Formula 8], Jₚ_{_{—}}ᵢ x and dp_i x are replaced in the new lines of the equality-constraint condition setting matrix A and the equality-constraint condition setting vector b, respectively.

Similarly, a link posture controller can be configured using a Jacobian form regarding to a link angular velocity. The posture angular velocity ω_i (three dimension vector) of the link i can be expressed by Jacobian J_{ω}_{_{—}}ᵢ (3 s×N matrix) regarding to the state variable dx/dt (N dimension vector) and the angular velocity of the link i.

$$ω\_i = {J}_{ω\_iz} \frac{d x}{d t} \qquad [ Numerical Formula 11 ]$$

Wherein, the Jacobian J_{ω}_{_{—}}ᵢ regarding to the angular velocity of the link i is given by the following equations:

the first row of J_{ω}_{_{—}}ᵢ=[0, 0, 0]^{T}

the second row of J_{ω}_{_{—}}ᵢ=[0, 0, 0]^{T}

the third row of J_{ω}_{_{—}}ᵢ=[0, 0, 0]^{T} [Numerical Formula 12]

the (k+3)th row of J_{ω}_{_{—}}ᵢ=0 (in the case where the link k does not exist on the straight line connecting between the base B and the link i), or z_k (in the case where the link k does not exist on the straight line connecting between the base B and the link i).

From the above [Numerical Formula 11], between the original point position minute variation dα_i of the link i posture (assumed to be expressed by an Eulerian angle) and the minute variation dx of the state variable x, the following relationship is approximately effected:

dα_{—}i=T_{—}i·J_{ω}_{_{—}}ᵢdx [Numerical Formula 13]

Wherein, T_i is a matrix converting an angular velocity vector into an Eulerian angular vector. Therefore, in the case where the movement constraint is required and imposed to the link i in the x, y, and z directions so as to generate the minute Eulerian angular variations dα_ix, dα_iy, dα_iz, respectively, the following equality constraints may be imposed.

dα_{—}ix=J_{α}_{_{—}}ᵢₓdx [Numerical Formula 14]

dα_{—}iy=J_{α}_{_{—}}_{iy}dx [Numerical Formula 15]

dα_{—}iz=J_{α}_{_{—}}_{iz}dx [Numerical Formula 16]

Wherein, J_{α}_{_{—}}ᵢx, J_{α}_{_{—}}ᵢy, and J_{α}_{_{—}}ᵢz designate the first, second, and third lines of the matrix (T_i Jω_i), respectively. When a link posture constraint is demanded to a link posture controller, the link posture controller establishes the coefficients of the above equations of [Numerical Formula 14] to [Numerical Formula 16] on new lines of the equality-constraint condition setting matrix A and the equality-constraint condition setting vector b in the equality-constraint condition setting space 2-7. For example, when the constraint regarding to the posture in the x direction of the link i is demanded, according to the equation [Numerical Formula 14], J_{α}_{_{—}}ᵢx and dα_ix are replaced in the new lines of the equality-constraint condition setting matrix A and the equality-constraint condition setting vector b, respectively.

A link gravity center position controller can be configured in the same way as in the link original point position controller. That is, the gravity center position velocity dr_i/dt (three dimension vector) of the link i can be expressed by Jacobian Jᵣ_{_{—}}ᵢ (3×N matrix) regarding to the state variable dx/dt (N dimension vector) and the gravity center position velocity of the link i.

$$\frac{dr\_i}{d t} = {J}_{pg\_i} \frac{d x}{d t} \qquad [ Numerical Formula 17 ]$$

The Jacobian J_{pg}_{_{—}}ᵢ regarding to the original point position velocity of the link i can be obtained by the following equations:

the first row of Jᵣ_{_{—}}ᵢ=[1, 0, 0]^{T}

the second row of Jᵣ_{_{—}}ᵢ=[0, 1, 0]^{T}

the third row of Jᵣ_{_{—}}ᵢ=[0, 0, 1]^{T} [Numerical Formula 18]

the (k+3)th row of J_{ω}_{_{—}}ᵢ=0 (in the case where the link k does not exist on the straight line connecting between the base B and the link i), or z_k×(r_i-p_k) (in the case where the link k does not exist on the straight line connecting between the base B and the link i).

Wherein the z_k expresses the vector of the joint k in the rotation axial direction; and the r_i and the p_k designate the positions of the link i gravity center and the link k, respectively (see FIG. 5). From the above [Numerical Formula 17], between the gravity center position minute variation dr_i of the link i and the minute variation dx of the state variable x, the following relationship is approximately effected:

dr_{—}i=Jᵣ_{_{—}}ᵢdx [Numerical Formula 19]

Therefore, in the case where the movement constraint is required and imposed to the gravity center position of the link i in the x, y, and z directions so as to generate the minute variations dr_ix, dr_iy, dr_iz, respectively, the following equality constraints may be imposed:

dr_{—}ix=Jᵣ_{_{—}}ᵢₓdx [Numerical Formula 20]

dr_{—}iy=Jᵣ_{_{—}}_{iy}dx [Numerical Formula 21]

dr_{—}iz=jᵣ_{_{—}}_{iz}dx [Numerical Formula 22]

Wherein, Jᵣ_{_{—}}ᵢx, Jᵣ_{_{—}}ᵢy, and Jᵣ_{_{—}}ᵢz designate the first, second, and third lines of Jᵣ_{_{—}}ᵢ, respectively. When a link gravity center position constraint is demanded to a link gravity center position controller, the link gravity center position controller establishes the coefficients of the above equations of [Numerical Formula 20] to [Numerical Formula 22] on new lines of the equality-constraint condition setting matrix A and the equality-constraint condition setting vector b in the equality-constraint condition setting space 2-7. For example, when the constraint regarding to the link gravity center position in the x direction is demanded, according to the equation [Numerical Formula 20], Jᵣ_{_{—}}ᵢx and dr_ix are replaced in the new lines of the equality-constraint condition setting matrix A and the equality-constraint condition setting vector b, respectively.

An entire gravity center position controller imposes constraints on the gravity center position of the entire robot. The entire gravity center position velocity dr/dt (three dimension vector) can be expressed by a state variable velocity dx/dt (N dimension vector) and a Jacobian Jr (3×N matrix)

$$\frac{d r}{d t} = {J}_{r} \frac{d x}{d t} \qquad [ Numerical Formula 23 ]$$

The Jacobian Jᵣ regarding to the gravity center position velocity of the robot can be obtained by the following equation:

$${J}_{r} = {\sum }_{i = 1}^{i = N} m\_i / M {J}_{r\_i} \qquad [ Numerical Formula 24 ]$$

Where m i denotes a mass of the link i; M a mass of the entire robot; and Jᵣ_{_{—}}ᵢ a Jacobian regarding to the gravity center position velocity of the link i. From the above [Numerical Formula 23], between the gravity center position minute variation dr of the entire robot and the minute variation dx of the state variable x, the following relationship is approximately effected:

dr=Jᵣdx [Numerical Formula 25]

Therefore, in the case where the movement constraint is required and imposed to the gravity center position of the entire robot in the x, y, and z directions so as to generate the minute variations dr_x, dr_y, dr_z, respectively, the following equality constraints may be imposed:

dr_{—}x=Jᵣ_{_{—}}ₓdx [Numerical Formula 26]

dr_{—}y=Jᵣ_{_{—}}_{y}dx [Numerical Formula 27]

dr_{—}z=Jᵣ_{_{—}}_{z}dx [Numerical Formula 28]

Wherein, Jᵣ_{_{—}}ₓ, Jᵣ_{_{—}}_{y}, and Jᵣ_{_{—}}_{z} designate the first, second, and third lines of Jᵣ, respectively. When a gravity center position constraint of the entire robot is demanded to the entire gravity center position controller, the entire gravity center position controller establishes the coefficients of the above equations of [Numerical Formula 26] to [Numerical Formula 28] on new lines of the equality-constraint condition setting matrix A and the equality-constraint condition setting vector b in the equality-constraint condition setting space 2-7. For example, when the constraint regarding to the gravity center position of the entire robot in the x direction is demanded, according to the equation [Numerical Formula 26], Jᵣ_{_{—}}ₓx and dr_x are replaced in the new lines of the equality-constraint condition setting matrix A and the equality-constraint condition setting vector b, respectively.

An entire angular momentum controller imposes constraints on the angular momentum variation of the entire robot. The angular momentum L (three dimension vector) of the entire robot can be expressed by a state variable velocity dx/dt (N dimension vector) and a Jacobian J_{L} (3×N matrix) regarding to the angular momentum of the entire robot.

$$L = {J}_{L} \frac{d x}{d t} \qquad [ Numerical Formula 29 ]$$

The Jacobian J_{L} regarding to the angular momentum of the entire robot can be obtained by the following equation:

$${J}_{L} = {\sum }_{i = 1}^{i = N} X ( m\_i ( r\_i - r ) ) {J}_{r\_i} + l\_i {J}_{ω\_i} \qquad [ Numerical Formula 30 ]$$

Wherein, X(v) denotes a skew-symmetric matrix for converting the exterior-product calculation of a vector into matrix representation; m_i a mass of the link i; rj a gravity center position of the link i; r a gravity center position of the entire robot; Jᵣ_{_{—}}ᵢ a Jacobian regarding to the gravity center position velocity of the link i; I_i an inertia matrix of the link i; and J_{ω}ᵢ a Jacobian regarding to the angular velocity of the link i. From the above [Numerical Formula 30], between the angular momentum minute variation dL of the entire robot and the minute variation dx of the state variable x, the following relationship is approximately effected:

dL=J_{L}dx [Numerical Formula 31]

Therefore, in the case where the movement constraint is required and imposed to the angular momentum of the entire robot in the x, y, and z directions so as to generate the minute variations dL_x, dL_y, dL_z, respectively, the following equality constraints may be imposed:

dL_{—}x=J_{L}_{_{—}}ₓdx [Numerical Formula 32]

dL_{—}y=J_{L}_{_{—}}_{y}dx [Numerical Formula 33]

dL_{—}z=J_{L}_{_{—}}_{z}dx [Numerical Formula 34]

Wherein, J_{L}_{_{—}}ₓ, J_{L}_{_{—}}_{y}, and J_{L}_{_{—}}_{z} designate the first, second, and third lines of Jᵣ, respectively. When an entire gravity center position constraint of the robot is demanded to the entire gravity center position controller, the entire gravity center position controller establishes the coefficients of the above equations of [Numerical Formula 32] to [Numerical Formula 34] on new lines of the equality-constraint condition setting matrix A and the equality-constraint condition setting vector b in the equality-constraint condition setting space 2-7. For example, when the constraint regarding to the angular momentum of the entire robot about the x direction is demanded, according to the equation [Numerical Formula 32], J_{L}_{_{—}}ₓ x and dL_x are replaced in the new lines of the equality-constraint condition setting matrix A and the equality-constraint condition setting vector b, respectively.

A joint angle controller can be easily configured as follows, for example. That is, the deviation Δθₖ between the present joint angle θₖ and the target joint angle θₖ_{_{—}}ₒ of the joint k is to follow the equation below.

Δθₖ=θₖ_{_{—}}₀−θₖ [Numerical Formula 35]

In this case, the equality constraint shown in the equation below may be imposed.

dθₖ=Δθₖ [Numerical Formula 36]

When a constraint is demanded so that the joint angular displacement of the joint k becomes Δθₖ. According to the above equation of [Numerical Formula 36], e_{k+3}^{T} and Δθₖ are replaced on new lines of the equality-constraint condition setting matrix A and the equality-constraint condition setting vector b, respectively. Where e_{k+3} is an N dimension unit vector with one (k+3)th element.

Similarly, an inequality constraint condition setter group can also be configured. For example, when the maximum angular velocity of the joint k is dθₖ/dt_max, the joint angular velocity controller may be imposed by the inequality constraint condition as shown in the equation below.

$$\vert d {θ}_{k} \vert \leq \frac{d {θ}_{k}}{dt\_max} d t \qquad [ Numerical Formula 37 ]$$

Regarding to a movable angle controller, when the present joint angle is θk; the maximum joint angle θₖ_{_{—}}ₘₐₓ; and the minimum joint angle θₖ_{_{—}}ₘᵢₙ of the joint k, the inequality constraint condition shown in the following equation may be imposed:

θₖ_{_{—}}ₘᵢₙ−θₖ≦dθₖ≦θₖ_{_{—}}ₘₐₓ−θₖ [Numerical Formula 38]

In any of the inequality condition setters, coefficients of the above-inequality equations are established on the inequality constraint condition setting matrix C and the inequality constraint condition setting vector d within the inequality constraint condition setting space 2-8.

Also, regarding to the redundancy drive method setter group, according to manners in setting values of the matrix and vector, various strategies for driving redundancies can be applied. For example, in a redundancy drive method setter for a state variation minimizing norm for minimizing the state variation from the preceding time:

$$E = \frac{1}{2} {dx}^{T} dx \qquad [ Numerical Formula 39 ]$$

the redundancy drive method setting matrix W and the redundancy drive method setting vector u may be established within the redundancy drive method setting space 2-9 so as to satisfy the above equation. That is, the system is configured so as to establish the below equation:

W=I, u=O [Numerical Formula 40]

Also, in a redundancy drive method setter of a state variation minimizing norm for minimizing the deviation to a target state xO:

$$F = \frac{1}{2} {\sum }_{i = 1}^{i = N} w\_i {( x0\_i - ( x\_i + dx\_i ) )}^{2} \qquad [ Numerical Formula 41 ]$$

so as to minimize coefficients including dx of the above equation;

$$E = \frac{1}{2} {dx}^{T} diag ( w\_i ) dx + {( w \vert x - x0 )}^{T} dx \qquad [ Numerical Formula 42 ]$$

the redundancy drive method setting matrix W and the redundancy drive method setting vector U may be established within the redundancy drive method setting space 2-9. That is, the system is configured so as to establish the below equation:

W=diag(w_{—}i), u=(w|x−x0) [Numerical Formula 43]

Where w denotes an N dimension vector having the ith factor with a positive real number w_i; and xO_i denotes the ith element of xo. Also, diag (w_i) denotes an N×N diagonal matrix having the ith diagonal element of w_i; and (a|b) denotes an N dimension vector having the ith element with the ith element of a multiplied by the ith element of b.

According to the configuration described above, a legged mobile robot can be controlled so as to operate by determining the allocation of the dive amount of each joint in real time so as to simultaneously satisfy various constraint conditions imposed during execution.

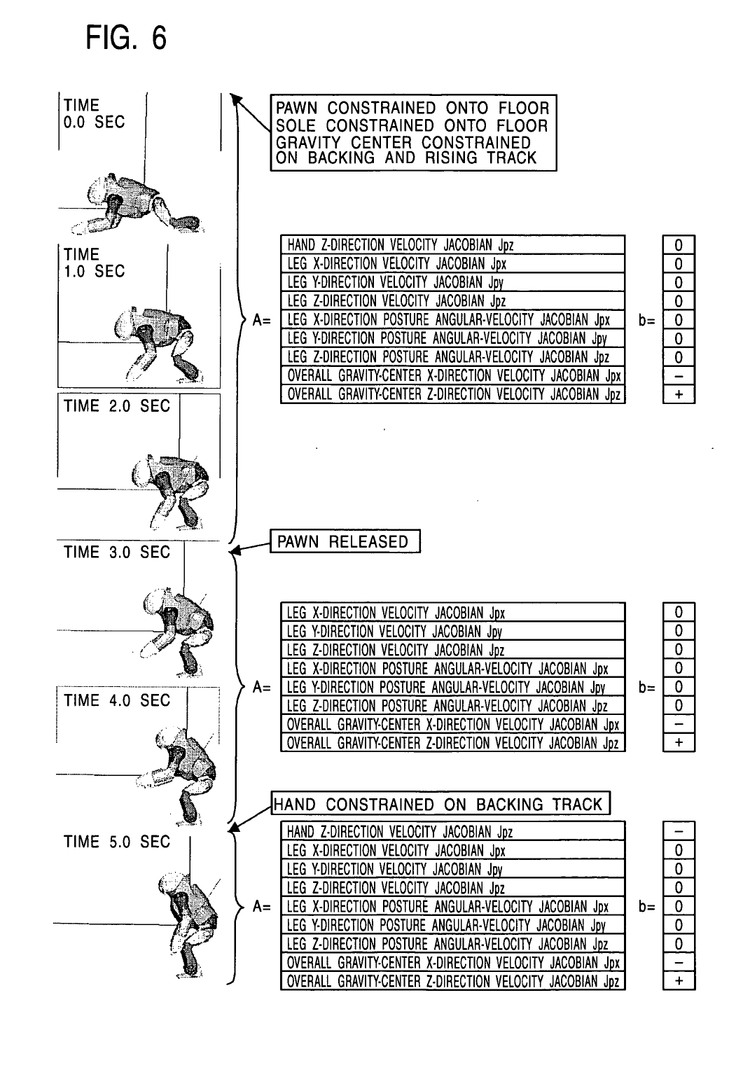

FIG. 6 shows an example in that the control system according to the present invention is incorporated in arising movement control of a legged mobile robot.

Between time 0.0 sec and time 2.0 sec, constraints are imposed on a robot so that the height of pawns is constrained on a floor; the position and posture of soles are constrained on the floor; and the gravity center traces a backing and rising track. These constraints are entered via the equality constraint condition setting unit 2-1 as constraints regarding to the state variation of the system after the control cycle dt, and appropriate values are established to the equality-constraint condition setting matrix A and the equality-constraint condition setting vector b within the equality-constraint condition setting space 2-7 by the equality-constraint condition setter group 2-4.

As shown in FIG. 6, in this period, on each row of the equality-constraint condition setting matrix A, a Jacobian regarding to a hand section in the Z direction, a velocity Jacobian of a leg section in the X, Y, and Z directions, a posture angular velocity Jacobian of the leg section in the X, Y, and Z directions, and a Jacobian of the entire gravity center in the X, Y, and Z directions are recalculated every control cycles and replaced, while on the row regarding to the gravity center position constraint of the equality-constraint condition setting vector b, a displacement which must be changed during the control cycle (symbol +denotes a positive value; symbol − negative) is replaced, and on the row other than the above, 0 designating the variation 0 is replaced.

In the example shown in the drawing, a state-variation minimizing norm is used for the redundancy drive method. Quadratic programming problems are solved every control cycles so as to satisfy these constraint conditions. Based on the results, moving states of the entire body are depicted as images on the left column of the drawing. In this period, it may be understood from the drawing that the entire body is driven so as to satisfy the entire constraint conditions while appropriately using the redundancies.

Upon approaching time 3.0 sec, the constraint regarding to the hand section in the Z direction is cancelled. After that time, it is understood that the row regarding to the hand section in the Z direction is not inserted in the equality-constraint condition setting matrix A and the equality-constraint condition setting vector b. Also from the images on the left column, it can be seen that the constraint to the pawn is released so that the hand section starts to rise.

Furthermore, upon approaching time 5.0 sec, for pulling the hand section to the waist, a new constraint is imposed to the hand section so as to follow the backing track. In connection with this, rows regarding to the hand position constraint in the X direction are inserted in the equality-constraint condition setting matrix A and the equality-constraint condition setting vector b.

From the images on the left column, it may be understood that the entire body is subsequently driven so that the X-coordinate of the hand section decreases. In such a manner, by the control system according to the present invention, dynamic changes in the constraint condition during the operation of body can be easily corresponded only by the update of the values of the matrix and vector, so that the allocation of the drive amount for the entire joints of the body can be determined in real time so as to entirely satisfy the demanded constraint conditions.

The present invention has be described with reference to a specific embodiment in detail. However, it is obvious that those skilled in the art can make modifications within the scope and spirit of the present invention.

The scope of the present invention is not necessarily limited to a product called as a “robot”. That is, products pertaining to other industrial fields such as toys may similarly incorporate the present invention as long as the products are machines or general movable devices simulating human movements.

After all, the present invention has been disclosed by exemplification, so that the description of this specification must not be definitely construed. In order to determine the spirit of the present invention, the attached claims must be considered.

As described below in detail, according to the present invention, an excellent movement control system can be provided for a legged walking robot capable of simultaneously executing a plurality of tasks such as a displacement, balance keeping, and an arm operation.

Also, according to the present invention, an excellent movement control system can be provided for a legged walking robot capable of determining the allocation of the drive amount of each joint in real time so as to simultaneously satisfy various movement constraint conditions imposed by each task.

Also, according to the present invention, an excellent movement control system can be provided for a legged walking robot capable of operating by suitably allocating drive amounts of degrees of freedom of an entire body so as to simultaneously satisfy geometrical/dynamical and ever-changing various movement constraint conditions.

The control system according to the present invention is not definitely applied to a specific movement state such as walking but has high versatility applicable to an arbitrary movement state of a legged mobile robot. In a legged mobile robot arbitrarily structured with open links, arbitrary constraints expressed by linear equality equations and linear inequality equations regarding to state variations can be imposed, such as geometrical constraints about positions and postures at every points of links, constraints about the entire momentums, and inequality constraints about movable ranges and drive velocities of actuators. According to the present invention, various movement constraints can be imposed to a legged mobile robot in an arbitrarily moving state, enabling more various tasks to be executed.

The control system according to the present invention also has an advantage that the system can correspond to dynamic changes in the movement constraint conditions imposed to a moving legged mobile robot without being limited to fixed movement constraint problems. The movement constraints imposed to a legged mobile robot are changeable in time corresponding to the moving state and the demanded task of the robot. According to the present invention, to such ever changeable constraint conditions, the system can correspond not with a fixed individual algorithm (such as inverted kinematics using analytical solution) but with a simplified and unified framework that is value changing in a matrix element. Therefore, the system can easily and promptly correspond to ever changing various constraint conditions, achieving a legged robot capable of flexibly corresponding to demanded tasks.

In the control system according to the present invention, for the drive method of redundancies, a plurality of drive strategies of the redundancies are established so as to be dynamically switchable. The optimum drive method of redundancies of a legged robot is dynamically changeable according to the robot conditions and kinds of task. According to the present invention, a plurality of redundancy drive methods such as the minimization of the deviation of the target state of the system given in advance and the minimization of system state changes can be changed only by the establishing method of the matrix value, easily achieving a legged robot driven according to situations based on the optimum coordinating method of the entire body.

What is claimed is:

1. A movement control system for a robot having a base and a plurality of movable regions connected to the base, the system comprising:
fundamental constraint-condition setters for setting movement constraint-conditions, which are imposed in accordance with a task and a movement state applied to the robot, for each kind of constraint;
a constraint-condition setting unit for imposing the movement constraint conditions of the entire robot necessary for a state variation of the robot by selectively using the appropriate fundamental constraint-condition setter in accordance with a movement-constraint requirement produced during execution of a task and a movement of the robot; and
a drive-amount determining unit for determining a drive amount of each of the movable regions so as to satisfy the entire movement-constraint conditions set by the constraint-condition setting unit.

2. A system according to claim 1, wherein the plurality of movable regions comprise at least an upper limb, a lower limb, and a body section.

3. A system according to claim 1, wherein a posture angle of the entire robot is expressed using a virtual joint angle of a virtual link.

4. A system according to claim 1, wherein each of the fundamental constraint-condition setters for each kind of constraint expresses movement constraint conditions imposed in accordance with a task and a movement state of the robot as a linear equality of a variation of a state variable.

5. A system according to claim 4, wherein each of the fundamental constraint-condition setters expresses a constraint equation by a Jacobian form.

6. A system according to claim 1, wherein each of the fundamental constraint-condition setters expresses a movement constraint condition imposed in accordance with a task and a movement state of the robot as a linear inequality equation of a variation of a state variable.

7. A movement control system for a robot having a base and a plurality of movable regions connected to the base, the system comprising:
fundamental redundancy drive-method setters for setting redundancy drive-methods, which are changed in accordance with a task and a movement state applied to the robot, for each kind of norm;
a redundancy drive-method setting unit for setting redundancy drive-methods of the entire robot by selectively using the appropriate fundamental redundancy drive-method setter in accordance with a requirement for changes generated during execution of a task and a movement of the robot; and
a drive-amount determining unit for determining a drive amount of each of the movable regions so as to satisfy the redundancy drive-method set by the redundancy drive-method setting unit.

8. A movement control system for a robot having a base and a plurality of movable regions connected to the base, the system comprising:
equality-constraint condition setters for expressing movement constraint-conditions, which are imposed in accordance with a task and a movement state applied to the robot, for each kind of constraint by a linear equality equation of a variation of a state variable;
an equality-constraint condition setting unit for imposing movement-constraint conditions of the entire robot necessary for a state variation of the robot by selectively using the appropriate equality-constraint condition setter in accordance with a requirement for a movement constraint generated during execution of a task and a movement of the robot;
inequality-constraint condition setters for expressing movement constraint-conditions, which are imposed in accordance with a task and a movement state applied to the robot, for each kind of constraint by a linear inequality equation of a variation of a state variable;
an inequality-constraint condition setting unit for imposing movement-constraint conditions of the entire robot necessary for a state variation of the robot by selectively using the appropriate inequality-constraint condition setter in accordance with a requirement for a movement constraint generated during execution of a task and a movement of the robot;
fundamental redundancy drive-method setters for setting redundancy drive-methods, which are changed in accordance with a task and a movement state applied to the robot, for each kind of norm;
a redundancy drive-method setting unit for setting redundancy drive-methods of the entire robot by selectively using the appropriate fundamental redundancy drive-method setter in accordance with a requirement for changes generated during execution of a task and a movement of the robot; and
a drive-amount determining unit for determining a drive amount of each of the movable regions so as to entirely satisfy equality and inequality-constraint conditions of the entire robot set by the equality-constraint condition setting unit and the inequality-constraint condition setting unit, and to entirely satisfy redundancy drive-methods of the entire robot set by the redundancy drive-method setting unit.

9. A system according to claim 8, wherein the plurality of movable regions comprise at least an upper limb, a lower limb, and a body section.

10. A system according to claim 8, wherein a posture angle of the legged walking robot is expressed using a virtual joint angle of a virtual link.

11. A system according to claim 8, wherein each of the equality-constraint condition setters expresses a constraint equation by a Jacobian form.

12. A system according to claim 8, wherein the drive-amount determining unit comprises:
a quadratic programming-problem solver for solving a variation of a state variable of the robot by formulating equality and inequality-constraint conditions of the entire robot and redundancy drive-methods of the entire robot as quadratic programming-problems; and
an integrator for calculating a state of the robot at a succeeding time by integrating a variation of a state variable.
